(19) United States
(12) Patent Application Publication
(10) Pub. No.: US 2007/0121282 A1
(43) Pub. Date: May 31, 2007

(54) Hinge structure for notebook computer

(75) Inventor: Chia-Ju Ho, Taipei (TW)

Correspondence Address: BACON & THOMAS, PLLC, 625 SLATERS LANE, FOURTH FLOOR, ALEXANDRIA, VA, 22314, US

(73) Assignee: Inventec Corporation, Taipei (TW)

(21) Appl. No.: 11/288,099

(22) Filed: Nov. 29, 2005

(51) Int. Cl. G06F 1/16

(52) U.S. Cl. 361/683

(57) ABSTRACT

A hinge structure for notebook computer is provided. The notebook computer includes a main body, a liquid crystal display (LCD) module, and a hinge unit. The hinge unit consists of two shaft holders, two shafts, and at least two annular bodies; the two shafts are mounted on the two shaft holders; the respective annular body is disposed with a gap and securely overlies the shaft. The two shaft holders are mounted on the main body of notebook computer with one end each screwed to the frame of LCD module. The hinge structure couples the main body and LCD module of the notebook computer together, and with the working of the hinge structure, it takes little force to open the LCD module and more force to close it.

### BACKGROUND OF THE INVENTION

1. Field of the Invention

The present invention relates to a hinge structure for notebook computer, more particularly a hinge structure that allows the alteration of notebook design and layout and obtains a torque for opening and closing the liquid crystal display module of the notebook computer characterized by light force for opening and heavy force for closing.

2. Description of the Related Art

The advancement of technology has made computer an indispensable tool for many people in work and/or in daily life. Besides, the high functionality, high speed, and portability of notebook computer have made it a popular device among business people and its popularity is gradually spread among individual users. The hinge structures for positioning or adjusting the angle of the liquid crystal display (LCD) module of notebook computers on the market are typically complex in construction. From the perspectives of industrial technology and cost, fabricating components with more complex structure demands higher technical level and poses more difficulty. Thus the assembly of components with complex structure tends to take longer, cost more, and permits less allowance given greater demand for precision, making it unsuitable for mass production. In addition, the whole structure won't be able to perform its originally designed functions if any of its elements breaks down or is damaged.

In the design of a notebook computer, another consideration in addition to appearance and style is its function layout. But after meeting the needs of users in functionality, the designer faces the problems of weight and volume. Given limited space, the designer must give and take between two contradicting design parameters, that is, giving the computer the most comprehensive and thoughtful functions possible, while keeping the notebook as light-weighted as possible.

In the design of a notebook computer, the battery is generally positioned at the front for the purpose of keeping the center of gravity of the entire notebook to the front. Such design will keep the main body of the notebook from overturning or tilting up when the LCD module is flipped open because the hinge shaft is longer than the front arm of the notebook. But because the battery of a notebook requires more room, the front part of the notebook is largely occupied by this component alone. As a result, many other devices, such as USB, IR, IO, SD or RJ45 are arranged at the rear part of notebook. That means users must go around to the rear of notebook to connect to ports each time they want to use those functions, which is inconvenient and inergonomic. If the battery which is infrequently used can be moved to the rear of notebook, the front part of notebook will have more space for housing the aforementioned devices, making it easier for users to access those functions.

The purpose of this invention is to redesign the hinge structure for notebook computer that can achieve gravity balance for the notebook without placing battery at its front.

### SUMMARY OF THE INVENTION

Addressing the drawbacks of prior art, the object of the present invention is to provide a hinge structure for notebook computer that remedies the drawback of conventional notebook computer that typically has its battery mounted at the front for the purpose of achieving gravity balance when it is opened, but arranges other devices at a spot not conveniently accessed by the user.

The present invention provides a hinge structure for notebook computer. The notebook computer includes a main body, a liquid crystal display (LCD) module, and a hinge unit. The hinge unit consists of two shaft holders, two shafts, and at least two annular bodies; the two shafts are mounted on the two shaft holders; the respective annular bodies are disposed with a gap and securely overlie the two shafts. The two shaft holders of the hinge unit are first mounted on the main body of notebook computer with one end each screwed to the frame of LCD module. Therefore, the hinge unit couples the main body of the notebook computer and the LCD module. When the LCD module is opened, the respective shaft rotates to the gap on the annular body of hinge unit without encountering any friction in the absence of a support, hence saving the force for opening and not causing the whole notebook to overturn or jerk up along with the LCD module. And it will take more force to close the LCD module.

The aforesaid hinge structure for notebook computer is a C-shaped body in single piece or multiple pieces. The shaft holders, shafts and annular bodies of the hinge structure are made of metallic material.

The hinge structure for notebook computer is an invention drawn on many years of design experience and offers a number of advantages and enhanced effects as compared to prior art.

1. The hinge structure for notebook computer according to the present invention is arranged with annular bodies, which allow the opening of LCD module with less effort than that required by conventional hinge structure.

2. The hinge structure for notebook computer according to the present invention is arranged with annular bodies which require more force for closing the LCD module as compared to conventional hinge structure, hence rendering the coupling of LCD module to the main body of notebook computer more solid and supporting the weight of LCD module.

3. The hinge structure for notebook computer according to the present invention allows the rearrangement of devices in the computer to make them more easily accessible and more ergonomically positioned.

The features and implementation of the present invention are explained in detail below with accompanying drawings.

### BRIEF DESCRIPTION OF THE DRAWINGS

FIG. 1 is a schematic view of the hinge structure according to the invention in place when the notebook computer is in opened state;

FIG. 2 shows a structural diagram of the hinge structure according to the invention;

FIG. 3 is a schematic view of the hinge structure according to the invention in place when the notebook computer is in closed state;

FIG. 4A is a schematic view of the hinge structure containing a single annular body that requires light force for opening;

FIG. 4B is a schematic view of the hinge structure containing a single annular body that requires heavier force for closing;

FIG. 5A is a schematic view of the hinge structure containing multiple annular bodies that requires light force for opening; and

FIG. 5B is a schematic view of the hinge structure containing multiple annular bodies that requires heavier force for closing.

### DETAILED DESCRIPTION OF THE INVENTION

The assembly and implementation of a preferred embodiment of the present invention are presented below with accompanying drawings.

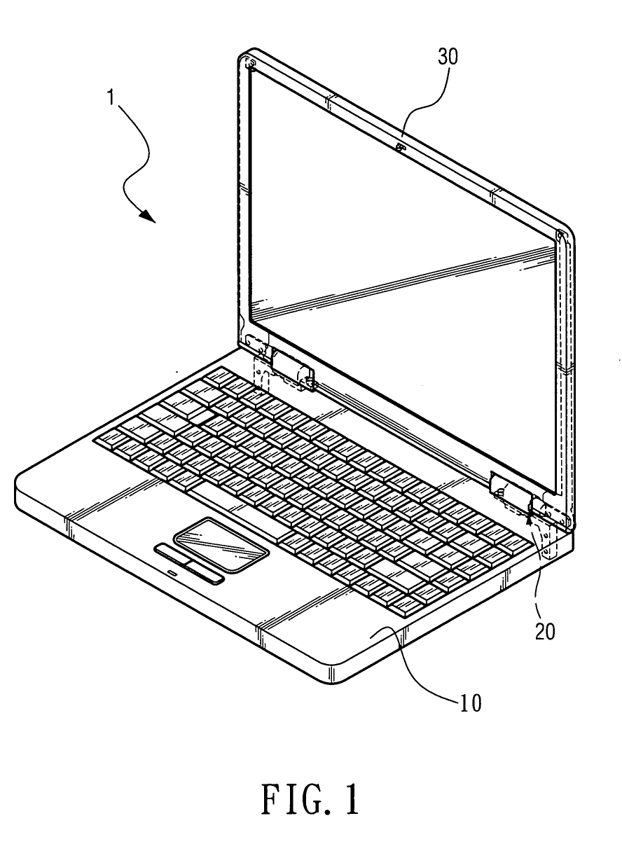

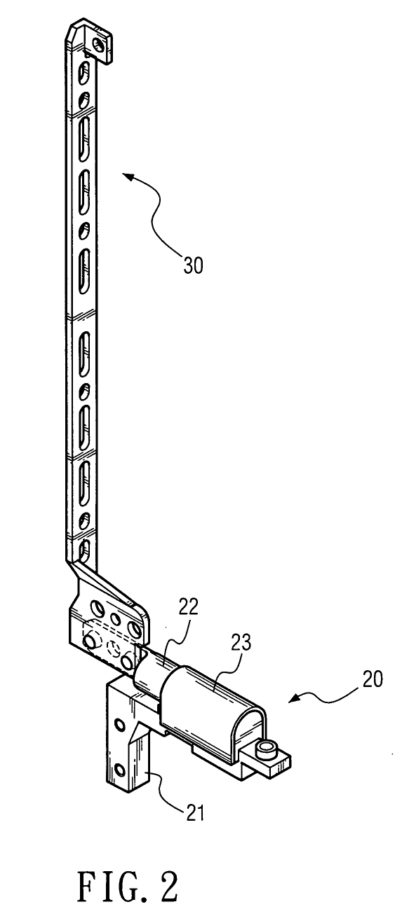

Referring to FIG. 1, a schematic view of the hinge structure in place when the notebook computer is in opened state, and FIG. 2, a structural diagram of the hinge structure, the present invention relates to a hinge structure for notebook computer. The notebook computer 1 includes a main body 10, a hinge unit 20, and a liquid crystal display (LCD) module 30. The hinge unit 20 consists of two shaft holders 21, two shafts 22, and at least two annular bodies 23; the two shafts 22 are mounted on the two shaft holders 21; the respective annular body 23 is disposed with a gap and securely overlies the shafts 22. After the main body 10 and LCD module 30 of the notebook computer 1 are coupled together through the hinge unit 20, the LCD module 30 may be opened and closed.

A preferred embodiment of the hinge structure for notebook computer according to the invention is presented below to illustrate how it allows the opening of LCD module with light force and requires heavier force to close.

Referring to FIG. 1 and FIG. 2, the two shaft holders 21 of the hinge unit 20 are first mounted on the main body 10 of notebook computer 1, and one end of the respective shaft 22 of the hinge unit 20 is screwed to the frame of LCD module 30. As such, the hinge unit 20 couples the main body 10 and LCD module 30 of the notebook computer 1 together. When the LCD module 30 of the notebook computer 1 is opened, the annular bodies 23 of the hinge unit 20 keep the force required small without causing the whole notebook computer 1 to overturn or tilt up along with the LCD module 30.

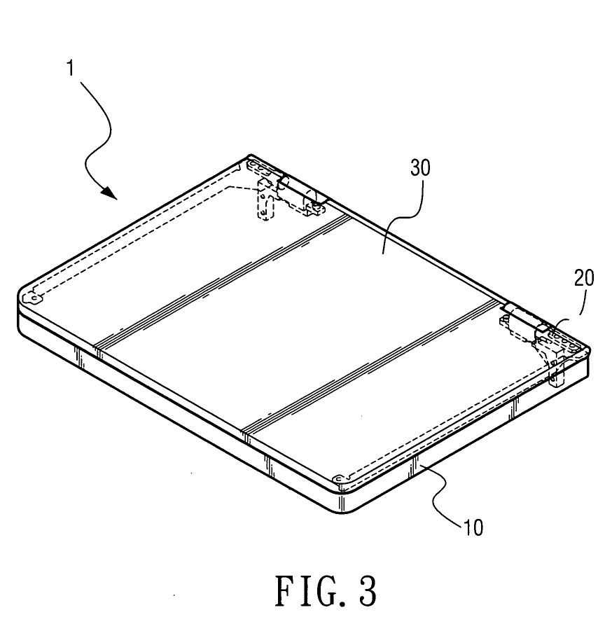

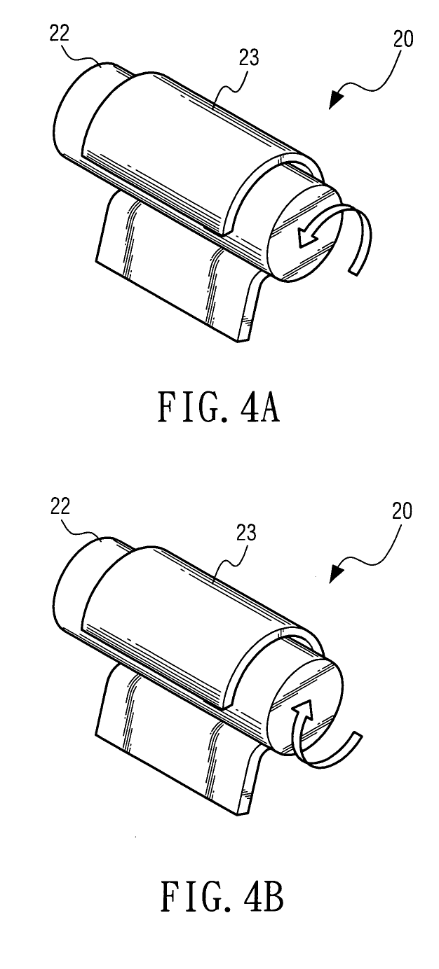

Referring to FIG. 1 and FIG. 4A (a schematic view of the hinge structure containing a single annular body that requires light force for opening), the annular body 23 lies over the shaft 22 of hinge unit 20 and is disposed with a gap. When opening the LCD module 30, the shaft 22 rotates in backward direction towards the gap of annular body 23 without encountering any friction for there is no point of support at the gap. As the torque becomes relatively smaller, the LCD module 30 can be opened without much force. When closing the LCD module 30, the shaft 22 rotates in forward direction towards the gap of annular body 23 as shown in FIG. 3 and FIG. 4 B (a schematic view of the hinge structure containing a single annular body that requires heavier force for closing). Because the friction between shaft 22 and annular body 23 during the rotation is getting bigger and bigger, the torque becomes greater and it takes more force to close the LCD module 30.

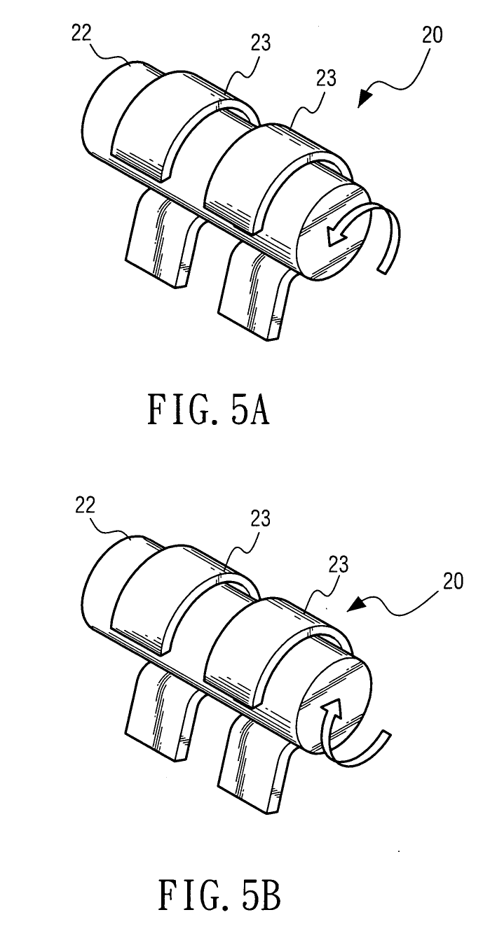

The annular body 23 of the hinge unit 20 is a C-shaped body in one piece as disclosed in the embodiment herein, which however should not be constructed as a limitation on the invention. When it is desired to enable the notebook computer 1 to adjust its torque for opening and closing, hinge unit 20 may have a plurality of annular bodies 23. As shown in FIG. 5A and FIG. 5B, when a plurality of annular bodies 23 are disposed on notebook computer 1, the torque for opening and closing the LCD module 30 of notebook computer 1 may be customized by increasing or decreasing the number of annular body 23 overlying the shaft. The shaft holder 21, shaft 22 and annular body 23 of the hinge unit 20 are made of metallic material.

The description above is merely a preferred embodiment of the invention which should not be construed as a limitation on the scope of claim. All modifications and alterations by those familiar with the skill without departing from the spirits of the invention shall remain within the protected scope and claims of the invention.

What is claimed is:

1. A hinge structure for notebook computer, the notebook computer comprising:
a main body, a liquid crystal display (LCD) module, and a hinge unit; wherein the hinge unit further comprising:
two shaft holders securely mounted on the main body of notebook computer; two shafts securely disposed on the shaft holders with one end of each shaft screwed to the LCD module; and
at least two annular bodies, each having a gap and overlying the shaft;
wherein the hinge unit couples the main body and LCD module of the notebook computer together and allows the torque for opening and closing the LCD module to be light force for opening and heavy force for closing.

2. The hinge structure according to claim 1, wherein the annular bodies are in C-shape.

3. The hinge structure according to claim 1, wherein the annular bodies come in one piece or multiple pieces.

4. The hinge structure according to claim 1, wherein the shaft holders are made of metallic material.

5. The hinge structure according to claim 1, wherein the shafts are made of metallic material.

6. The hinge structure according to claim 1, wherein the annular bodies are made of metallic material.
